(19) United States
(12) Patent Application Publication
(10) Pub. No.: US 2016/0071072 A1
(43) Pub. Date: Mar. 10, 2016

(54) AUTOMATOUS PAYMENT SYSTEM, METHOD AND APPARATUS

(71) Applicant: MasterCard International Incorporated, Purchase, NY (US)

(72) Inventors: Paul J. Bailo, Trumbull, CT (US); Scott J. Griffin, Newtown, CT (US)

(21) Appl. No.: 14/482,260

(22) Filed: Sep. 10, 2014

(51) Int. Cl. G06Q 20/10; G06Q 30/02

(52) U.S. Cl. CPC G06Q 20/102; G06Q 30/0201

(57) ABSTRACT

A system, method, and computer-readable storage medium configured to model and predict payment intentions of a payment cardholder based on cardholder behavior, and to make payments on the cardholder's behalf.

### BACKGROUND

1. Field of the Disclosure

Aspects of the disclosure relate in general to financial services. Aspects include an apparatus, system, method and computer-readable storage medium to model and predict payment intentions of a payment cardholder based on cardholder behavior, and to make payments on the cardholder's behalf.

2. Description of the Related Art

Virtually every consumer is familiar with paying bills. In any given month, the average person may have a housing payment (either a mortgage or rent), transportation bills (such as gas, car payment, or public transit payments), grocery bills, and utility bills (such as water, electricity, television, or internet provider bills).

Paying bills can be a time-consuming and annoying task.

The use of payment cards, such as credit or debit cards, is ubiquitous in commerce. Typically, a payment card is electronically linked via a payment network to an account or accounts belonging to a cardholder. These accounts are generally deposit, loan or credit accounts at an issuer financial institution. During a purchase transaction, the cardholder can present the payment card in lieu of cash or other forms of payment.

Payment networks process trillions of purchase transactions by cardholders. The data from the purchase transactions can be used to analyze cardholder behavior. Typically, the transaction level data can be used only after it is summarized up to customer level. Unfortunately, the current transaction rolled-up processes are pre-knowledge based and does not result in transaction level models. For example, a merchant category code (MCC) or industry sector are to classify purchase transactions and summarize transactions in each category. This kind of summarization of information is a generic approach without using target information.

### SUMMARY

Embodiments include a system, apparatus, device, method and computer-readable medium configured to model and predict payment intentions of a payment cardholder based on cardholder behavior, and to make payments on the cardholder's behalf.

In an autonomous payment network method embodiment, the method receives customer data, the customer data including a transaction attribute. A processor generates a customer level target specific variable layer from the customer data. The processor models customer purchasing behavior with the customer level target specific variable layer to create a model of customer purchasing behavior. The model of customer purchasing behavior is saved to a non-transitory computer-readable storage medium.

An autonomous payment network server embodiment comprises a processor and a non-transitory computer-readable storage medium. The processor is configured to receive customer data. The customer data includes a transaction attribute. The processor is further configured to generate a customer level target specific variable layer from the customer data, and to model customer purchasing behavior with the customer level target specific variable layer to create a model customer purchasing behavior. A non-transitory computer-readable storage medium is configured to save the model of customer purchasing behavior.

A non-transitory computer readable medium embodiment is encoded with data and instructions. When executed by a computing device, the instructions causing the computing device to receive customer data, the customer data including a transaction attribute. A processor generates a customer level target specific variable layer from the customer data. The processor models customer purchasing behavior, via the processor, with the customer level target specific variable layer to create a model customer purchasing behavior. The non-transitory computer-readable storage medium is configured to save the model of customer purchasing behavior.

### BRIEF DESCRIPTION OF THE DRAWINGS

FIG. 1 illustrates an embodiment of a system configured to model and predict payment intentions of a payment cardholder based on previous behavior, and to make payments on the cardholder's behalf.

FIG. 2 depicts a data flow diagram of a payment server configured to model and predict payment intentions of a payment cardholder based on previous behavior, and to make payments on the cardholder's behalf.

FIG. 3 depicts a data flow diagram of a payment network configured to model and predict payment intentions of a payment cardholder based on previous behavior, and to make payments on the cardholder's behalf.

### DETAILED DESCRIPTION

One aspect of the disclosure is the realization that automating bill paying and purchasing is a useful and productive way of increasing user satisfaction and loyalty.

Another aspect of the disclosure includes the realization that a cardholder's behavior patterns may be predicted by their electronic presence, such as their payment card spending, social network associations, their electronic calendar, and electronic records of other forms of bill payments.

These behavior patterns may in turn be indicators and predictors for other types of spending.

An aspect of the disclosure includes predicting a cardholder's future purchase or bill paying intentions improves fraud-prevention on the payment card.

Another aspect of the disclosure includes the understanding that predicting a cardholder's future intentions can create opportunities to increase cardholder satisfaction through offering convenience by automatically paying cardholder bills and making purchases on behalf of the cardholder. Ancillary services may include the automatic purchase of items for the cardholder or associates of the cardholder. For example, when a system sees that a cardholder's mother is about to celebrate a birthday, realizes that the cardholder previously sent flowers to mom, the system may automatically purchase flowers from an e-commerce floral vendor for mom. Other embodiments may automatically pay outstanding utility bills on the cardholder's behalf.

Yet another aspect of the disclosure is the realization that a predictive model of cardholder behavior may be applied to automatically enable services for the cardholder.

In the following description of embodiments, the terms “cardholder” and “customer” are used interchangeably, and understood to refer to a user of the embodiments.

Embodiments of the present disclosure include a system, method, and computer-readable storage medium configured to model and predict payment intentions of a payment cardholder based on previous behavior, and to make payments on the cardholder's behalf. For the purposes of this disclosure, a payment card includes, but is not limited to: credit cards, debit cards, prepaid cards, electronic checking, electronic wallet, mobile device or other electronic payments.

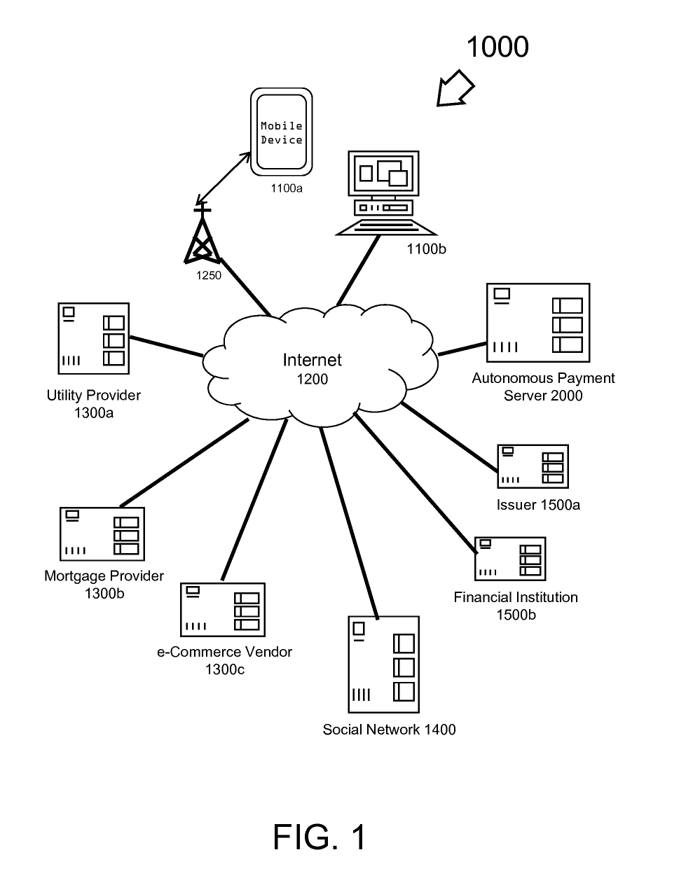

FIG. 1 illustrates an embodiment of a system 1000 configured to model and predict payment intentions of a payment cardholder based on previous behavior, and to make payments on the cardholder's behalf, constructed and operative in accordance with an embodiment of the present disclosure.

System 1000 includes consumers using computing devices 1100a-b to connect to vendors 1300a-c, social networks 1400, financial institutions 1500a-b, or an autonomous payment server 2000 via a data network, such as a mobile telephone or data network 1250, the Internet 1200, and the like.

Computing devices 1000 may be mobile devices 1100a (such as a personal digital assistant (PDA), tablet computers or mobile phones), personal computers 1100b (including laptop or notebook computers), or any other device in the art capable of electronic communications over a data network.

Vendors 1300 are providers any known in the art that provides goods or services to consumers. Vendors 1300 may bill the customer electronically, by mail, or in person. These vendors 1300 may include, for example, utility providers 1300a, mortgage providers 1300b, or any electronic commerce vendor 1300c known in the art.

A social network 1400 is an online service platform, or site that focuses on building and reflecting of social relations among people. The site allows for people who share interests or activities to make their own communities. The social network 1400 includes a representation of each user (often a profile) and social links. The social network 1400 may be based on the World Wide Web (“WWW” or “web”) and allow users to interact over the Internet 1200 via e-mail and instant messaging. The social network 1400 allow users to share ideas, activities, events, and interests within their individual networks.

Financial institutions 1500 include payment card issuers 1500a, banks, credit unions or any other financial institutions 1500b known in the art that facilitating customers to make payments. In some embodiments, customers may bank at the financial institution 1500, and have checking, savings, or other types of accounts known in the art. In some instances, a financial institution may also include a mortgage provider 1300b.

Autonomous payment server 2000 includes the set of API functions, processes, and data that allow the autonomous payment server 2000 to predict the bills and payments that a customer would ordinarily make, and then make payments on the customer's behalf. These may include utility bills from a utility provider 1300a, mortgage payments from a mortgage provider 1300b, or other goods-and-services provided by an e-commerce vendor 1300c, for example. Autonomous payment server 2000 may make payments to the vendors 1300a-c using customer payment cards issued by an issuer 1500a or with customer checking accounts at a financial institution 1500b, as appropriate.

The functionality and methods used by autonomous payment server 2000 are described in greater detail below.

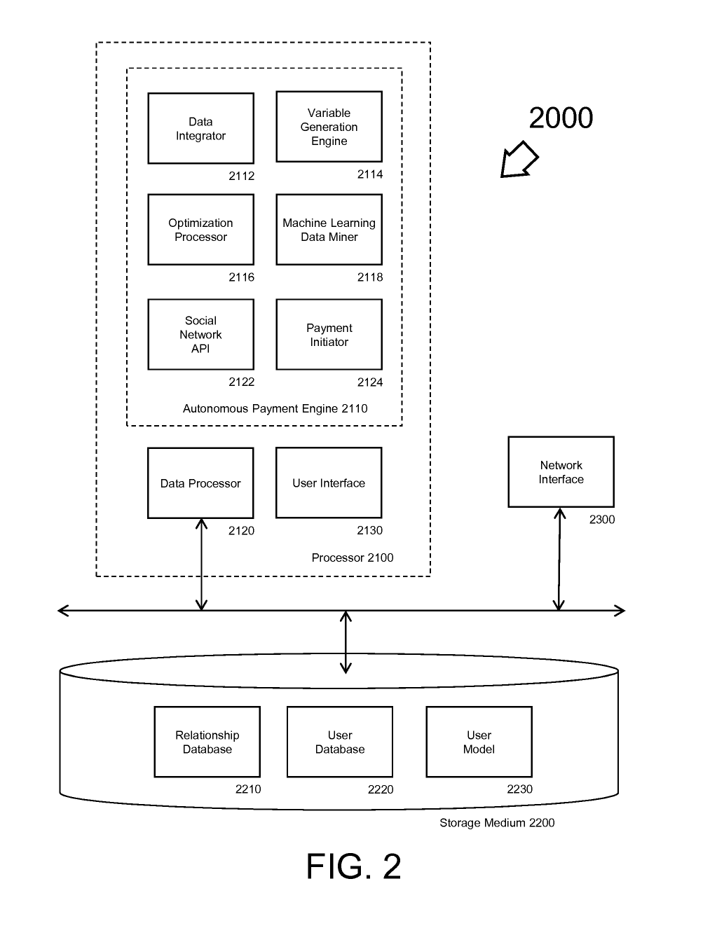

Embodiments will now be disclosed with reference to a block diagram of an exemplary autonomous payment server 2000 of FIG. 2 configured to model and predict payment intentions of a payment cardholder based on previous behavior, and to make payments on the cardholder's behalf, constructed and operative in accordance with an embodiment of the present disclosure.

Autonomous payment server 2000 may run a multi-tasking operating system (OS) and include at least one processor or central processing unit (CPU) 1100, a non-transitory computer-readable storage medium 2200, and a network interface 2300.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of an autonomous payment engine 2110, a user interface 2130, and a data processor 2120.

Autonomous payment engine 2110 may further comprise: a data integrator 2112, variable generation engine 2114, optimization processor 2116, a machine learning data miner 2118, a social network application program interface (API) 2122 and a payment initiator 2124.

Data integrator 2112 is an application program interface (API) or any structure that enables the autonomous payment engine 2110 to communicate with, or extract data from, a database.

Generally, variable values are usually global—they are the same regardless of where they are evaluated. An exception is target-specific variable values. This feature allows a system to define different values for the same variable, based on the target, in this case, a customer. Variable generation engine 2114 is any structure or component capable of generating customer level target-specific variable layers from given transaction level data.

Optimization processor 2116 is any structure configured to receive target variables from a transaction level model defined from a business application and refine the target variables.

Machine learning data miner 2118 is a structure that allows users of the autonomous payment engine 2110 to enter, test, and adjust different parameters and control the machine learning speed. In some embodiments, machine learning data miner 2118 uses artificial intelligence, decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof. In one example, machine learning data miner may be an artificially intelligent computer system capable of answering questions posed in natural language, such as Watson, developed by International Business Machines Corporation of Armonk, N.Y.

Social network API 2122 is the structure that allows autonomous payment engine 2110 to communicate and extract relationship and other information from social network 1400.

Payment initiator 2124 may be any structure that facilitates payment from customer accounts at a financial institution 1500 to a vendor 1300. The customer accounts include payment card accounts, checking accounts, savings accounts and the like.

User interface 2130 may be any electronic interface known in the art that allows customers to communicate with the autonomous payment engine 2110. In some embodiments, user interface 2130 may communicate with a customer via telephone using a natural language processor. In such an embodiment, user interface 2130 may phone the customer to inform them of options or actions taken by autonomous payment server 2000. In other embodiments, user interface 2130 may include a web-based interface that allows customers to enter information electronically, and or import data files. These data files may include checking account information, payment card, savings account information, employer information, or electronic tax returns.

Data processor 2120 enables processor 2100 to interface with storage medium 2200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows autonomous payment server 2000 to communicate with vendors, cardholders, and/or issuer financial institutions.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a relationship database 2210, user database 2220, and a user model 2230. Relationship database 2210 is configured to store records of personal customer relationships derived from social network 1400 via social network API 2122. User database 2220 is configured to store user information, such as payment card and account information, transaction information related to specific users, and any other user-related information. A user model 2230 may be a model of anticipated user expenditures based at least in part on payment card transactions, issuer payment data, vendor purchase data or customer relationships.

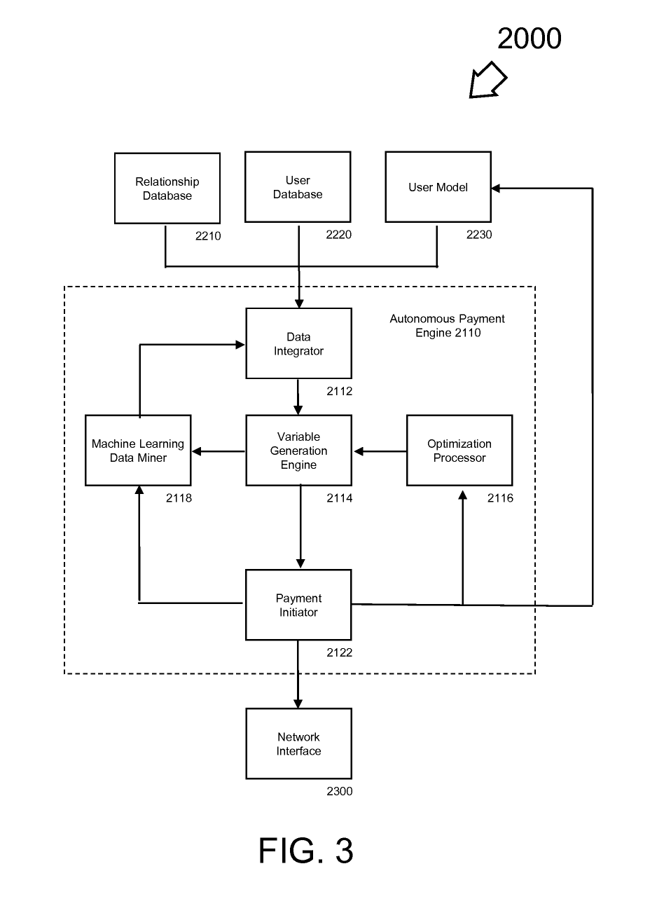

It is understood by those familiar with the art that one or more of these databases 2210-2230 may be combined in a myriad of combinations. The function of these structures may best be understood with respect to the data flow diagram of FIG. 3, as described below.

We now turn our attention to the method or process embodiments of the present disclosure described in the data flow diagram of FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 is a data flow diagram of an autonomous payment engine method to model and predict payment intentions of a payment cardholder based on previous behavior, and to make payments on the cardholder's behalf, constructed and operative in accordance with an embodiment of the present disclosure. The resulting user model 2230 may be used in predicting and making payments on a customer's behalf, fraud prevention, convenience and cardholder services, vendor offers and the like.

Method 2000 may be a real-time or batch method that enables transaction level modeling and prediction of payment intentions of a payment cardholder based on previous behavior, and to make payments on the cardholder's behalf.

As shown in FIG. 3, data integrator 2112 receives data from a relationship database 2210, user database 2220, and user model 2230. Customers may upload data into the user database 2220 from their personal computer via interface 2130. This uploaded data may include employer information, financial data, passwords to on-line accounts (such as financial, social network and vendor accounts), and calendar data. Once social network passwords are provided to the autonomous payment engine 2110, social network API 2122 may periodically access the customer's social networking accounts to update customer relationship information in the relationship database 2210. Additionally, as the autonomous payment engine 2110 learns from its previous actions (e.g., by artificial intelligence, fuzzy logic or the like), it also takes input from a user model 2230 that it generates. User model 2230 is a predictive model of customer purchase behavior.

User database 2220 is configured to store past travel cardholder behavior as discovered from addendum messages in payment card transactions. Addendum messages contain additional information needed for specific types of transactions. Addendum messages are used heavily in commercial payment card products (corporate cards, purchasing cards, small business cards, travel & entertainment cards, fleet, and the like). The addendum message may include information about: passenger transport (i.e. airline ticket, train ticket) detail, trip leg information, vehicle rentals, lodging, payment detail (additional information about receipt of funds), telephony billing services (conference call providers, mobile phones, and the like), electronic invoice (business-to-business information not provided on other addendums), travel agency detail, corporate fleet (fleet transportation details, such as gasoline purchases), lodged account detail (detail for lodging addendum), corporate line item detail, temporary services (services rendered on a temporary or contract basis), shipping/courier services and the like.

For example, for an individual customer's user model 2230, the cardholder's individual data may be received from user database 2220. Embodiments can automatically learn and generate customer level target specific variable layer from given transaction level data.

Data integrator 2112 provides the data to the variable generation engine 2114. For any user model 2230 with at least one transaction attribute of interest, Xᵢ (A; t, l) can denote a transaction attribute variable at transaction level belonging to an account A, by transaction time stamp t, and transaction location 1. For example, X can be payment amount or any transaction related attribute, and V_{A} (x) can be a summarized variable at the customer level which can be any function of original transaction attribute x for a given user model 2230, designated as target T.

Once generated, the transaction attribute of interest is provided to the user interface 2130 and the machine learning data miner 2118. The machine learning data miner 2118 receives inputs from both the variable generation engine 2114 and the user interface 2130 to refine the user model 2230. Machine learning data miner 2118 starts with dozens of attributes of the transaction data, and computes the implicit relationships of these attributes and the relationship of the attributes to the user interface 2130. The machine learning data miner 2118 derives from or transforms these attributes from transaction-level attributes to account-level attributes (a process called “rolling-up”), then selects the “rolled-up” attributes variables for the variable generation engine 2114.

Payment initiator 2122 also feeds information to optimization processor 2116. The optimization process happens after the variables are created by modeling processes:

$$V ( x ) {\to }^{Model} T .$$

Optimization processor 2116 maximizes the correlation of the generated variables V with the target T by searching optimal mapping [symbol] and roll-up function [symbol] :

$$\{ {X}_{i} ( A ; t , ) \} {\to }^{Specific and to Maximize relevant V \to T} {V}_{A} ( x , T )$$

The searching space for the optimal mapping and functions is large, and the optimization processor 2116 may test the searching process with a limited domain. For example, one simplified approach is to fix the function dimension [symbol] = [symbol] , and searching the optimal mapping [symbol] .

In essence, the optimization processor 2116 learns from vast transactional data, explores target relevant data dimensions, and generates optimal customer level variable summarization rules automatically to describe the likelihood that a cardholder will take a particular action. It may do so using any artificial intelligence technique known in the art. In some embodiments, the optimization processor performs a regression technique on the transactional data to look into the past to mimic a known outcome and project the results to predictively model the future actions of the cardholder. The factors that impact the outcome being studied are characteristics observed prior to the outcome.

The optimization processor 2116 starts with selected variables (attributes) of each account (customer) rather than of each transaction. For example, suppose an account has ten transactions. The optimization processor 2116 looks at the “sum” or “average” or any other aggregated attributes selected by the user interface 2130 of those ten transactions for the account. The optimization may be accomplished by computing the relationship of these variables to the business application, and rolling-up from transaction level attributes to account-level attributes.

The feedback from optimization processor 2116 and machine learning data miner 2118 provides a machine learning approach for transactional data to customer optimization problem. The business applications 1130 are not limited to credit transaction data; it can be applied to any multiple-layer optimization problems such as issuer payment data and merchant purchase data, checking and savings account data, to automatically generate and implement optimal algorithms to facilitate the analytic and scoring productions. Using these techniques to analyze past purchase behavior, future purchase behavior can be predicted. In this context, predicted future purchase behavior is the likelihood of the customer to make a future purchase, which can be expressed in a myriad of ways without deviating from the spirit of the disclosure. In some embodiments, the predicted future purchase behavior may be expressed as a probability to make a purchase from zero (entirely unlikely) to one (100% chance of purchase), or scored between zero (unlikely) and 1,000 (100% chance). It is understood that predicted future purchase behavior may alternatively expressed as a ratio of the customer's past purchase behavior (i.e., 3:1 likelihood to purchase flowers around Mother's Day), or an indication of high, medium or low predicted future purchase behavior depending on how recently an item or service is purchased purchased (i.e., <2 weeks=high, 2 weeks-1 month=medium and >1 month=low). For example, a customer who purchases flowers more than 1 month in advance of Mother's Day, may have a high likelihood of buying additional gifts for mom, whereas travelers who purchase their flowers within 2 weeks of departure have an even higher likelihood of buying additional “last-minute” gifts.

In some embodiments, the payment initiator 2122 may specifically target customers with a predicted future purchase behavior with relevant advertisements or offers. For example, suppose that based on a cardholder's spending, autonomous payment engine 2110 determines that the cardholder is likely to purchase flowers for Mother's Day; user interface 2130 may then target the cardholder with an offer for flowers, or ancillary offers, such as an offer for chocolate. In such an embodiment, user interface 2130 may telephone the customer, and present the offer. In other embodiments, user interface 2130 may present the offers via electronic mail, short message service (SMS), or any other electronic message service known in the art.

In other embodiments, the payment initiator 2122 may automatically make purchases and payments on the customer's behalf, based on the customer's prior payment behavior. Such an embodiment may automatically purchase flowers for Mother's Day based on the customer's past purchase patterns. In this aspect, when a customer is determined to have high likelihood to pay their mortgage at a certain time period, the likelihood is factored into the future purchase behavior. Payment initiator 2122 may make payments using any method provided by the customer and stored in user database 2220, including customer payment cards, and customer checking or savings accounts.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An autonomous payment method comprising:
receiving customer data, the customer data including a transaction attribute;
generating, via a processor, a customer level target specific variable layer from the customer data;
modeling customer purchasing behavior, via the processor, with the customer level target specific variable layer to create a model customer purchasing behavior;
saving the model of customer purchasing behavior to a non-transitory computer-readable storage medium.

2. The payment network method of claim 1, wherein the customer data includes customer financial data.

3. The payment network method of claim 2, wherein the customer data includes customer relationship data.

4. The payment network method of claim 3, wherein at least a portion of the customer relationship data is received from a social network.

5. The payment network method of claim 4, wherein the customer financial data includes one or more of payment card data, savings account data, checking account data or employment data.

6. The payment network method of claim 5, wherein the transaction attribute includes a transaction account, a transaction time, and a transaction location.

7. The payment network method of claim 6, the generating the customer level target specific variable layer comprises:
summarizing the transaction attribute at a customer level.

8. The payment network method of claim 7, the modeling further comprising:
performing a roll-up function with the processor.

9. The payment network method of claim 8, the modeling further comprising:
searching an optimal mapping to correlate the customer level target specific variable layer with the model of customer purchasing behavior.

10. The payment network method of claim 9, wherein the generating the customer level target specific variable layer further comprises:
receiving feedback from the model of customer purchasing behavior.

11. The payment network method of claim 10, further comprising:
automatically paying a bill based on the model of customer purchasing behavior, via a network interface.

12. The payment network method of claim 10, further comprising:
automatically making a purchase based on the model of customer purchasing behavior, via a network interface.

13. An autonomous payment network server comprising:
a processor configured to receive customer data, the customer data including a transaction attribute, to generate a customer level target specific variable layer from the customer data, to model customer purchasing behavior, with the customer level target specific variable layer to create a model customer purchasing behavior;
a non-transitory computer-readable storage medium configured to save the model of customer purchasing behavior.

14. The autonomous payment network server of claim 13, wherein the customer data includes customer financial data.

15. The autonomous payment network server of claim 14, wherein the customer data includes customer relationship data.

16. The autonomous payment network server of claim 15, wherein the customer relationship data is received from a social network.

17. The autonomous payment network server of claim 16, wherein the customer financial data includes payment card data, savings account data, checking account data or employment data.

18. The autonomous payment network server of claim 17, wherein the transaction attribute includes a transaction account, a transaction time, and a transaction location.

19. The autonomous payment network server of claim 18, the generating the customer level target specific variable layer comprises:
summarizing the transaction attribute at a customer level.

20. A non-transitory computer-readable medium encoded with data and instructions, when executed by a computing device the instructions causing the computing device to:
receive customer data, the customer data including a transaction attribute;
generate, via a processor, a customer level target specific variable layer from the customer data;
model customer purchasing behavior, via the processor, with the customer level target specific variable layer to create a model customer purchasing behavior;
save the model of customer purchasing behavior to the non-transitory computer-readable storage medium.
